(19) United States
(12) Patent Application Publication
(10) Pub. No.: US 2020/0173098 A1
(43) Pub. Date: Jun. 4, 2020

(54) COMPOSITION AND USE THEREOF FOR FINISHING TEXTILES

(71) Applicant: RUDOLF GMBH, Geretsried (DE)

(72) Inventors: Johann HEIMGREITER, Bairawies (DE); Rainer Wilhelm BRAUN, Bad Heilbrunn (DE); Gunther DUSCHEK, Benediktbeuern (DE)

(73) Assignee: RUDOLF GMBH, Geretsried (DE)

(21) Appl. No.: 16/621,041

(22) PCT Filed: Jun. 13, 2018
(86) PCT No.: PCT/EP2018/065640

§ 371 Date: Dec. 10, 2019

(30) Foreign Application Priority Data
Jun. 14, 2017 (EP) 17 175 979.8
Apr. 9, 2018 (EP) 18 166 361.8

(51) Int. Cl. D06M 13/148; D06M 13/17; D06M 13/224; D06M 13/256; D06M 13/262; D06M 13/288; D06M 13/295; D06M 15/267; D06M 15/356; D06M 15/61; D06M 23/02; C11D 1/94; C11D 17/00; C11D 17/04

(52) U.S. Cl. CPC D06M 13/148; D06M 2200/00; D06M 13/2243; D06M 13/256; D06M 13/262; D06M 13/288; D06M 13/295; D06M 15/267; D06M 15/3562; D06M 15/61; D06M 23/02; C11D 1/94; C11D 17/003; C11D 17/041; D06M 13/17

(57) ABSTRACT

The present invention relates to compositions comprising at least one cationic polyelectrolyte, at least one anionic compound and at least one non-ionic surfactant and their use for finishing textiles.

The present invention relates to compositions comprising at least one cationic polyelectrolyte, at least one anionic compound and at least one non-ionic surfactant and their use for finishing textiles.

Ever-increasing demands are placed on textiles today. Depending on the field of application, textiles are expected to be hydrophobic, hydrophilic, flame-retardant, antistatic, wrinkle-resistant, oil-repellent, weatherproof, etc.

These requirements can no longer be satisfied by the mere selection of a suitable fibre material. In the art, therefore, increasingly the surface of the fibres and/or textiles is chemically modified, i.e. finished to tailor the property profile of the textile according to the field of application. The finishing usually takes place directly at the manufacturers on an industrial scale. Textiles are usually made of fibres, whereby a distinction is made between natural fibres, i.e. fibres which are obtained without chemical modification from vegetable fibres, e.g. cotton, or animal fibres, e.g. wool or silk, and synthetic fibres. Unlike natural fibres, most synthetic fibres have significant advantages:
lower creasing tendency
high tear and abrasion resistance
high variability of the properties by choice of monomers
low weight
low production costs

Therefore, more synthetic fibres than natural fibres are currently being processed into textiles worldwide. However, despite their advantages, synthetic fibres also have disadvantages. For instance, synthetic fibres become more electrostatically charged compared to natural fibres. Also, the synthetic fibres hardly absorb moisture, which has a negative effect on their wearing comfort. Textiles made of synthetic fibres can therefore not be used in certain areas at all or only to a limited extent, e.g. by combination with natural fibres.

In order to impart antistatic and/or hydrophilising properties to synthetic fibres, so-called finishing agents can be used which are applied to the surface of the fibres or textiles. However, it is usually difficult to fix the finishing agent in a wash-permanent manner to synthetic fibres, since synthetic fibres have few or no functional groups that can permanently bind the finishing agent to the fibre or textile, for example by covalent, ionic or van der Waals interactions. To solve the problem, in most cases finishing agents are used which are self-crosslinking or can be crosslinked by another component. While such finishing agents usually have higher washing permanence, the textile feel of such finished textiles is unsatisfactory. In addition, the crosslinking reaction usually takes place at higher temperatures, for example at 150° C. Such reaction conditions are not suitable for all fibres and can lead to undesirable yellowing, chemical degradation reactions and changes in shape of the fibre and/or textile. For health reasons, crosslinkable finishing agents are also criticized, since the functional groups of the crosslinking agents, for example epoxy, chlorhydroxyl or (blocked) isocyanate groups, are suspected of being hazardous or even toxic. Finally, the high energy consumption for the finishing is ecologically questionable.

Alternatively, finishing with complexes of cationic and anionic preparations is proposed to achieve appropriate washing permanence on a fibre or textile. For this purpose, a two-stage process is usually carried out in which cationic and anionic components are applied successively.

EP 0 603 987 A1 describes a two-stage process in which a layer of cations and anions is applied successively to a substrate. The best washing permanence is achieved at a stoichiometric ratio between anions and cations, under which circumstances the hydrophilicity is insufficient. Although the hydrophilicity can be improved by varying the charge ratio between anions and cations, the washing permanence is adversely affected to the same extent. Acceptable hydrophilic properties with acceptable washing permanence are not achieved by the systems described.

In WO 2006/015080 A1, substrates are alternately cationic and anionic. In order to avoid deposits in the individual baths, a washing step takes place between the steps. The disadvantage of this method is that the polymers do not grow quantitatively, so precipitations form in the liquor, which deposit on the fibres or textiles and thereby cause stains. The washing step also involves a great deal of extra work and product loss.

In U.S. Pat. No. 6,060,410 B, a solution of a strongly sub-stoichiometric ratio of cationic and anionic molecules is applied to a substrate. The still free ionic groups are mixed in a second bath with an oppositely ionic hydrophobising component.

U.S. Pat. No. 5,208,111 B and US 2004/0185284 A1 also propose two-stage processes for the formation of complexes.

The described two-stage processes are associated with a high production cost, and at the same time it is difficult to ensure process stability, since there is the risk of unwanted deposits on fibre or textile due to the formation of insoluble complexes in the liquor.

Water-insoluble cation-anion complexes can also be used as solids. For this purpose, the complexes are usually precipitated in aqueous systems as ion pairs and then separated, dried and/or granulated. The products can be used in plastic mouldings or other non-aqueous formulations. For aqueous media finishing, these dried, water-insoluble complexes are not suitable because they are not sufficiently finely dispersed to avoid deposits and stains.

U.S. Pat. No. 6,596,678 B2 describes a powdered detergent composition with a polyelectrolyte complex of cationic and anionic polymers. The polyelectrolyte complex is present in the wash liquor as a particle which deposits on the textiles to be cleaned and protects them during the washing process. After subsequent rinsing, the complex is washed out again.

In WO 2011/131728 A1, an anion-cation complex precipitated in water is dried after filtration and used as an additive in plastic mouldings.

The above-described anion-cation complexes are all not suitable for finishing textiles, since a homogeneous application to the fibre or the textile is not possible or even may cause stains on the textile.

U.S. Pat. No. 3,622,378 B describes mixtures of anionic and cationic surfactants and an amphoteric surfactant. The complexes precipitate as soon as the mixture is diluted. Moreover, the treated fibres and textiles do not have the desired washing permanence.

DE 19 852 584 A1 and U.S. Pat. No. 6,060,410 B describe aqueous dispersions of cation-anion complexes. The dispersions are mechanically homogenized, for example by ultrasound. However, the liquor is only metastable and has a strong tendency to agglomerate. Thus, the liquor is suitable for use as a finishing agent only to a limited extent also because there is a risk that deposits and stains on the textile to be finished result.

EP 0 603 987 B1 relates to a permanent hydrophilic-cationic surface coating. The surface to be coated is dipped in an aqueous solution of a cationic surfactant and/or polymer. To form the ion complex, an anionic surfactant and/or polymer is applied to the surface. Alternatively, a dispersion of the anion-cation complex is proposed for the coating of filters. For the coating of fibres or textiles, the ion complex described is not suitable since it is not possible to produce sufficiently stable liquors.

In summary, the finishing agents according to the prior art have the following disadvantages:
complex multi-step processes in the application
finishing not feasible for the end user
handling hardening
thermal yellowing
use of physiologically questionable starting products
lack of washing permanence
risk of staining due to uncontrolled deposits

Frequently, there is also a desire on the part of the end user to impart certain properties to already existing textiles or to refresh certain properties of textiles. Thus, additives are known which are simply added to the wash water during the wash cycle, e.g. in (domestic) washing machines. Textiles treated in this way should, for example, have an improved water-repellent effect after washing. The additives can be used as a substitute or additive to conventional detergents. Alternatively, the additives may also be added to the washload in dosing units. The dosing unit ensures a controlled release of the additive during use, i.e. during the wash cycle. The dosing units allow the controlled release of the additive, for example, continuously over the entire wash cycle or gradually under certain conditions, e.g. when reaching a predetermined temperature or under mechanical load (e.g. during spinning). Such dosing units are known to the person skilled in the art and include, for example, so-called washcloths, dosing balls, tabs, pods or caps.

So far, it has not yet been possible to provide additives for the end-user market with which a textile can be given permanent antistatic and/or hydrophilic properties. Moreover, in the application of the additive in the domestic field, i.e. hand washing and (domestic) washing machines in particular, the highest requirements are demanded in terms of environmental compatibility and toxicity, since the wash water contaminated with the additive usually enters the wastewater untreated.

Surprisingly, the problem can be solved by providing a composition which includes
(A) at least one cationic polyelectrolyte,
(B) at least one anionic compound,
(C) at least one non-ionic surfactant and
(D) optionally, at least one liquid medium

The composition may be in the liquid or solid state, preferably the composition is in the form of colloid, granules or powder. In a preferred embodiment, the composition is in the form of a colloid. Here, the colloid particles preferably have an average diameter of 5 nm to 3 μm, more preferably 10 nm to 2 μm, even more preferably 40 nm to 1.5 μm, and even more preferably 40 nm to 500 nm. Preferably, the composition is optically transparent or opaque.

Polyelectrolytes are polymers with pendant or chain ionic groups. Thus, the cationic polyelectrolyte (A) is a polymer having pendant and/or chain cationic groups, especially pendant cationic groups. Preferably, the cationic group in the polyelectrolyte is permanently cationic, i.e. independent of the reaction conditions, for example independent of the pH.

The cationic group in the polyelectrolyte (A) is preferably an ammonium, pyridinium, imidazolium, pyrrolidinium or N-substituted heteroaromatic group, more preferably a quaternary ammonium group.

The polyelectrolyte (A) is preferably obtainable by (i) polymerisation of at least three monomer units each having a permanent cationic charge and/or (ii) by condensation reactions leading to at least three cationic groups and/or (iii) by alkylation of at least three amino functions in a polymer to permanent cationic groups.

The polyelectrolyte (A) may be a homo- or a copolymer. In the case where the polyelectrolyte is a copolymer, the copolymer may comprise at least one repetition unit attributable to a comonomer selected from the group consisting of styrene, acrylonitrile, (meth)acrylic acid ester, (meth)acrylamide, (meth)acrylic acid, vinyl acetate and allyl alcohol derivative. If the comonomers contain a chemically ionisable group, this can be converted after polymerisation to a permanently cationic group. Preference is given to chemically ionisable groups, for example amino groups, which can be reacted, for example, by alkylation to quaternary ammonium ions.

The permanent cationic charge in the monomer unit (i) is preferably an ammonium, pyridinium, imidazolium, pyrrolidinium or N-substituted heteroaromatic group, more preferably a quaternary ammonium group.

Preferred monomer units (i) are α, β-unsaturated hydrocarbon compounds which have a permanently cationic charge. Particularly preferred monomer units (i) are selected from the group consisting of diallyldialkylammonium salt, in particular diallyldimethylammonium chloride (DADMAC), trialkylammoniumalkyl(meth)acrylate salt and trialkylammoniumalkyl(meth)acrylamide salt.

Particularly preferred monomer units (i) are shown structurally below:

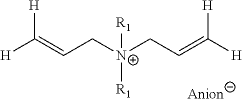

with
R₁=C₁₋₄-alkyl, preferably —CH₃,

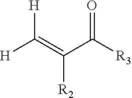

with

R₂=—H or —C₁₋₄-alkyl, preferably —CH₃, and
R₃=

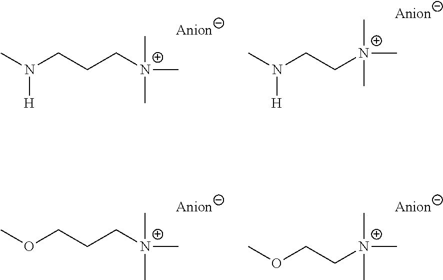

Alternatively, the cationic polyelectrolyte (A) can be prepared by condensation reactions leading to at least three cationic groups. Such a condensation reaction (ii) preferably comprises a reaction of at least one dialkylamine, tertiary alkyl and/or (hetero)aryl-diamine with at least one epihalohydrin and/or bis-halide. The epihalohydrin is preferably epichlorohydrin or epibromohydrin, more preferably epichlorohydrin. The bis-halide is preferably an α, ω-bis-halide, preferably α, ω-bis-alkyl halide or α, ω-bis-halide alkyl ether. Preferred amino-functional compounds for the condensation reaction (ii) with epihalohydrin and/or bis-halide include:

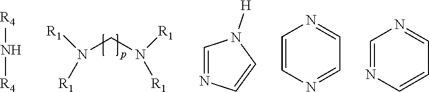

with
R₁ as defined above
R₄=—CH₃, —C₂H₅, —C₃H₇, —C₄H₉,
p=2-6.

In a further alternative, the polyelectrolyte (A) can be obtained by polymerisation of at least three monomer units, each having at least one chemically and/or physically ionisable group. Preferably, the chemically ionisable group is an amino group which can be reacted by alkylation to a quaternary ammonium ion. Preferably, therefore, in the alternative (iii), the polyelectrolyte (A) is obtained by alkylating at least three amino functions in a polymer to form permanent cationic groups.

Preference is given to polymers having at least three amino functions, selected from the group consisting of linear or branched polyalkylene imine, in particular polyethylene imine. Alternatively, polymers having at least three amino functions can be obtained by polymerisation of at least three monomer units each having at least one amino function, in particular diallyldialkylamine, vinylamine, vinylpyrazole, vinylimidazole and/or aziridine.

Preferred polymers having at least three amino functions are:

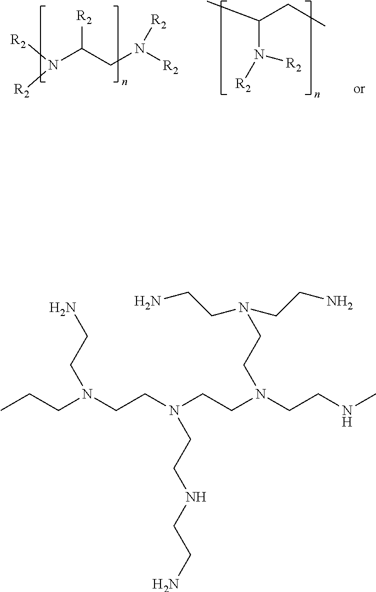

in which

R₂ is independent as defined above and

n is 3-100,000.

The conditions and alkylating reagents for the alkylation of the amino functions in the polymer are well known to those skilled in the art. Preferred alkylating reagents are, for example, dimethyl sulphate, diethyl sulphate, methyl halide, benzyl halide, methyl tosylate, or 3-chloro-2-hydroxypropyl-N,N,N-trimethylammonium chloride (CHPTAC).

The polyelectrolyte (A) preferably has a number average molecular weight of 1,000-5,000,000 g/mol, more preferably 1,000-1,000,000 g/mol, even more preferably 1,500-1,000,000 g/mol, and even more preferably 2,000-500,000 g/mol.

The polyelectrolyte (A) is preferably constructed such that 30-100 mol %, preferably 50-100 mol %, of the repetition units have a cationic group.

In a preferred embodiment, the cationic charge density of the cationic polyelectrolyte (A) is 2.0-14.0 meq/g, more preferably 2.3-13 meq/g, and most preferably 2.5-12 meq/g.

The composition contains the polyelectrolyte (A) preferably at 4-62 wt.-%, more preferably 5-55 wt.-%, based on the total mass of the components A, B and C.

The anionic compound (B) preferably has at least one, more preferably 1-3, i.e. 1, 2 or 3, anionic group(s). In another preferred embodiment, the anionic compound (B) is an anionic polyelectrolyte.

Preferably, the anionic compound (B) comprises at least one phosphate, phosphonate, sulphate, sulphonate, carboxylate, sulphoacetate, sulphosuccinate and/or taurate group.

In a further preferred embodiment, the anionic compound (B) is selected from mono-, di-(C₄₋₂₂-alkyl (alkoxy)) phosphate, mono-, di-(C₄₋₂₂-alkyl) phosphonate, C₄₋₂₂-alkylaminophosphonate, C₄₋₂₂-alkyl (alkoxy) sulphate, secondary alkyl sulphonate, petroleum sulphonate, C₄₋₂₂-alkyl sulphonate, C₄₋₂₂-alkylaryl sulphonate, fatty alcohol ether carboxylate, fatty acid salt, fatty alkyl sulphoacetate, fatty acid amide ether sulphate, fatty alcohol ether carboxylate, nonylphenol ether sulphate, fatty alkyl ether sulphate, C₄₋₂₂-alkylpolyalkoxylenphosphate and C₄₋₂₂-alkylpolyalkoxylensulphate.

Preferred mono- or dialkyl (alkoxy) phosphates or hydrogen phosphates are derived from the following acids:

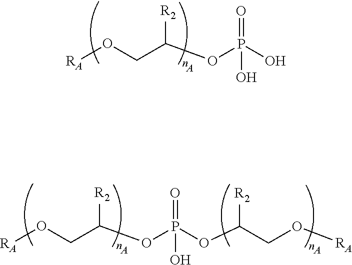

in which
R₂ is independent as defined above,
R_{A} is independently a saturated or unsaturated hydrocarbon radical having 4-18 carbon atoms,
n_{A} is independently 0-20.

A preferred alkyl alkoxy sulphate is derived from the following acid:

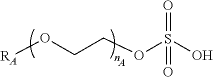

in which
R_{A2} is a saturated or unsaturated hydrocarbon radical having 8-18 carbon atoms, and
n_{A2} is independently 0-10.

A preferred alkylaryl sulphonate is derived from the following acid:

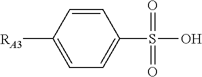

in which
R_{A3} is a saturated or unsaturated hydrocarbon radical having 8-20 carbon atoms.

Alternatively, the compound (B) may be an anionic polyelectrolyte. The polyelectrolyte (B) is preferably a polymer having pendant anionic groups. Such polyelectrolytes are preferably obtainable by polymerisation of at least three monomer units (iv), each having at least one chemically ionisable group.

The ionisable group in the monomer unit (iv) is preferably a group having an acidic proton, for example, an ionic group-bonded acid group. Such acid groups can be deprotonated in an acid-base reaction by adding a base. Preferred examples of the monomer unit (iv) are (meth)acrylic acid, maleic acid, 2-acrylamido-2-methylpropanesulphonic acid (AMPS), allylsulphonic acid and styrenesulphonic acid.

In a preferred embodiment, the polyelectrolyte (B) is a homo- or copolymer. The polyelectrolyte copolymer may comprise at least one repetition unit attributable to a comonomer, for example, selected from the group consisting of styrene, acrylonitrile, (meth)acrylic acid ester and (meth)acrylamide.

The anionic polyelectrolyte (B) is preferably constructed such that 30-100 mol %, preferably 50-100 mol %, of the repetition units have an anionic group.

The anionic compound (B) preferably constitutes 15-85 wt.-%, more preferably 20-80 wt.-%, based on the total mass of the components (A), (B) and (C).

Component (A) and component (B) together form an ionic complex. This ionic complex forms a nucleus to which the non-ionic surfactant (C) is bound via hydrophobic interactions.

In a preferred embodiment, the ratio of the net charge in component (A) to the net charge in component (B) is 1:10 to 10:1, more preferably 1:7 to 7:1.

The net charge of component (A) is equal to the sum of all positive charges minus the sum of any negative charges present. The net charge of component (B) corresponds to the sum of all negative charges less the sum of any positive charges present.

In a particularly preferred embodiment, the composition according to the invention comprises:

(A) at least one cationic polyelectrolyte,

(B) at least one anionic compound,

(C) at least one non-ionic surfactant and

(D) optionally at least one liquid medium,

wherein the composition is in the form of a colloid and the ratio of the net charge in component (A) to the net charge in component (B) is 1:10-10:1.

Component (C) is preferably an alkoxylation product of fatty acid, fatty acid ester, fatty acid amine, fatty acid amide, fatty alcohol, aliphatic mono-, di- or tri-alcohol, mono-, di- or tri-glyceride, alkylphenol, sorbitan fatty acid and sugar derivatives or trialkylphenol polyalkoxylene or a block copolymer, e.g. poly(ethylene oxide-co-propylene oxide).

In a more preferred embodiment, the non-ionic surfactant (C) is selected from the group consisting of alkoxylated C₉-C₂₅ fatty alcohols, alkoxylated C₉₋₂₅ fatty acid amines, C₉-C₂₅ alkoxylated fatty acid amides, C₈-C₂₅ fatty acids alkoxylated on the carboxylate function, alkoxylated C₈-C₂₅ fatty acid esters, alkoxylated C₈-C₂₆ alkylphenols and alkoxylated mono-, di- or triglycerides of C₈-C₂₅ fatty acids and/or their esterification products with C₈-C₂₅-fatty acids or trialkylphenylpolyalkoxylene or a block polymer, e.g. poly(ethylene oxide-co-propylene oxide), or fatty alcohol-poly (ethylene oxide-co-propylene oxide) and mixtures thereof. The number of alkoxy groups in the non-ionic surfactant is at least 8, preferably 8-85, more preferably 10-85, and most preferably 10-80 repetition units. The alkyl groups may each independently be branched or straight-chained, saturated or unsaturated.

Preferred non-ionic surfactants (C) are as follows:

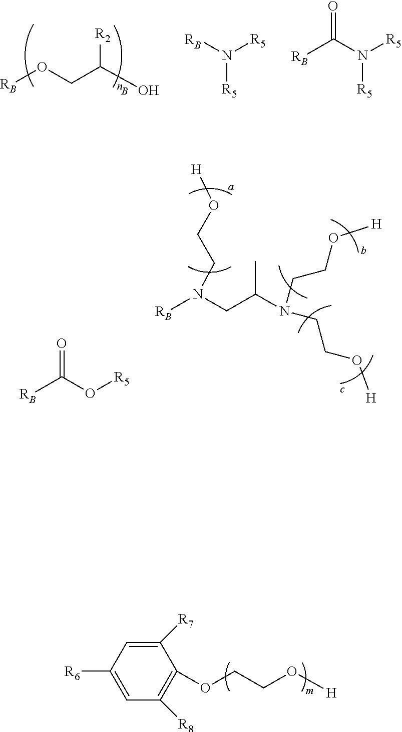

in which

R_{B} is a saturated or unsaturated hydrocarbon radical having 8-22 carbon atoms,

R₅ is independent

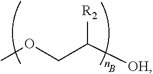

R₅, R₇ and R₈, are independently —H or a saturated or unsaturated hydrocarbon radical having 8-18 carbon atoms,

n_{B} is 8-80,

a+b+c is 10-115 and

m is 10-200.

The composition preferably contains 20-80 wt.-%, more preferably 30-60 wt.-%, of component (C) based on the total mass of components (A), (B) and (C).

The composition according to the invention may contain at least one liquid medium (D). The liquid medium is preferably a solvent, in particular water, or a polar organic solvent or a mixture thereof. Preferred polar organic solvents are alcohol, glycol, glycol ethers, ethers, ketone or mixtures thereof. The organic solvents are particularly preferably ethanol, isopropyl alcohol, glycerol, monoethylene glycol, diethylene glycol, 1,2-propylene glycol, dipropylene glycol, butyl diglycol, dipropylene glycol monomethyl ether, mono-, di-ethylene glycol monobutyl ether, N-methylpyrrolidone, acetone or mixtures thereof.

The composition according to the invention preferably contains 40-80 wt.-%, more preferably 50-80 wt. %, of component (D) based on the total composition.

Component (D) may be incorporated into the composition separately or together with the components of (A), (B) and (C). The composition may be present as a concentrate (e.g. 40-75 wt.-% of component (D) based on the total composition) or in diluted form.

The composition may further contain at least one textile auxiliary, for example an antistatic agent, a hydrophilising agent, a flame retardant, a softening agent, a de-wrinkling agent, a lubricant, a UV resistance agent, a corrosion inhibitor or a fluorine-free or fluoric hydrophobising agent.

To adjust the pH level of the composition, pH regulators may optionally be used. Suitable pH regulators are known to the person skilled in the art.

In a further aspect, the present invention relates to a method for the preparation of the composition described above comprising the steps:
a) Providing component (A), optionally in a liquid medium,
b) Providing component (B), optionally in a liquid medium,
c) Providing component (C), optionally in a liquid medium,
d) optionally, providing component (D) and
e) mixing the products obtained in steps a)-d).

For mixing the products obtained in steps a) to d) (step e), methods known to the person skilled in the art can be used. Preferably, step e) takes place with homogenizers known in the art, for example in the temperature range of 20-100° C.

In a further aspect of the invention, the composition according to the invention is used for the antistatic and/or hydrophilising finishing of textiles, in particular of linear or flat textiles, more preferably of flat textiles.

A “textile” in the context of the invention is made of several fibres. “Fibres” in the context of the present invention are natural fibres and synthetic fibres. “Natural fibres” are preferably cotton, wool or silk. “Synthetic fibres” or “synthetic fibres” are synthetically produced from natural or synthetic polymers and are preferably made of polyester, polyolefin, preferably polyethylene or polypropylene, more preferably polypropylene, polyamide, polyaramide, such as Kevlar® and Nomex®, polyacrylonitrile, spandex, or rayon. According to the invention, textiles may also contain mixtures of natural fibres and synthetic fibres.

Preferably, the textile is flat. “Flat textiles” are preferably knitted fabrics, fleeces, felts, woven fabrics, and meshes.

“Antistatic” finishing and/or “antistatic finishing” in the sense of the present invention means the increase of the electrical conductivity at the surface of the material to be finished, in order to counteract an electrostatic charge. The electrical resistance on the surface of the finished material is preferably 10⁹ to 9×10¹¹ ohms (measured in accordance with DIN EN 1149-1).

The hydrophilicity in the context of the present invention is the measure of the ability of a material to absorb water. A material is referred to as “hydrophilic” in the sense of the present invention if the absorbency of the material is 1-30 seconds according to the TEGEWA drip test.

Surprisingly, it has been found that textiles can already be finished by adding the composition according to the invention into the wash water, for example in (domestic) washing machines or in hand washing. For this purpose, the composition may be added as a concentrate or in diluted form. Preferably, the concentration of components (A), (B), (C) and optionally (D) in the wash water is 0.1-10 g/L, more preferably 0.3-8 g/L.

Alternatively, the composition according to the invention can be provided in a dosing unit, by means of which the composition according to the invention can be released in a controlled manner during the wash cycle, for example in a (domestic) washing machine. Such dosing units are known in the art and include so-called washcloths, tabs, caps, pods and dosing devices, e.g. dosing balls.

In one aspect, the invention therefore relates to a dosing unit comprising a composition according to the invention, in particular in the form of a washcloth, tabs, caps, pods or a dosing device.

In the case of tabs, the composition—preferably in solid form—is compressed into tablets (so-called tabs). The tabs gradually dissolve in the course of the wash cycle, thus allowing a continuous delivery of the composition to the laundry.

In the case of caps, the—preferably liquid—composition is, for example, packed in bags. The package is preferably such that it will leak at a predetermined temperature in the presence of water, and thus the timing of release of the composition during the wash cycle can be controlled.

Alternatively, the package is designed so that it leaks under mechanical stress, e.g. in the spin cycle. The packaging is preferably made of polyethylene or polypropylene.

In the case of pods, the—preferably liquid—composition is packaged, for example, in bags, analogously to the caps. The packaging is preferably such that it dissolves without residue under the given washing conditions. The packaging is therefore preferably made of degradable or soluble polymers, such as polyvinyl alcohol or polylactide.

In the case of the washcloth, a substrate is preferably impregnated with the composition according to the invention. The washcloth is added to the laundry in the drum of the (domestic) washing machine preferably at the beginning of the wash cycle. During the wash cycle, the composition migrates in a controlled manner into the wash water.

In a preferred embodiment, the substrate is a fleece, a woven fabric, a knitted fabric or felt. The substrate is preferably made of cellulose, for example cotton or rayon, polyethylene terephthalate, polyamide, polyolefin, in particular polypropylene or polyethylene and/or polyacrylonitrile. The substrates of the washcloths are preferably made of polyolefins, particularly preferably polypropylene, due to their favourable price and their low lint propensity.

The washcloth preferably has an area of <1600 cm², more preferably 10-1600 cm², even more preferably 20-1000 cm².

The mass ratio of the components (A), (B) and (C) in the composition to the substrate of the washing cloth is preferably 1:1 or 10:1 to 0.5:1.

The high local concentration of the composition as well as the ratio of the active substances (A), (B) and (C) allows a continuous migration of the composition into the wash water.

For all dosage units according to the invention, the amount of the composition should be selected such that the concentration of the components (A), (B), (C) and, optionally, (D) in the wash water at the finish cycle is 0.1-10 g/L, preferably 0.3-8 g/L. Preferably, after washing, the textile is finished with about 0.01-1 wt.-%, more preferably 0.01-0.8 wt.-%, of the components (A), (B) and (C), based on the total mass of the textile.

The washcloths according to the invention can be used for one or more washes, preferably for at least 1, 2, 5 or 10 washes, for example at 95° C. The washcloths can also be finished with other active substances, such as detergents, softeners, conditioners, fragrances, etc.

The washcloths according to the invention can be produced according to the following steps:
(i) providing a substrate,
(i) applying the preparation according to the invention to the substrate and
(iii) optionally at least partially removing liquid medium (D) at temperatures above room temperature and optionally at reduced pressure.

The composition according to the invention can preferably be prepared according to the known methods, for example by spraying, dipping, impregnating, brushing or sponge application or forced application, or exhaust method. The washcloths are preferably produced by treating the substrate with the concentrate of the composition according to the invention. The method according to the invention may further comprise an after-treatment step (iv) in which the impregnated substrate is completely dried and/or fixed. Step (iv) may be carried out at 80-160° C., preferably at 100-130° C.

Accordingly, a further subject of the invention is the use of the dosing unit according to the invention for the antistatic and/or hydrophilising finishing of textiles, preferably in washing machines, in particular in domestic washing machines.

Surprisingly, it has been found that the compositions according to the invention are suitable for providing textiles with antistatic and hydrophilic properties. In addition, it has been shown that the finishing is wash-permanent. “Washing permanence” in the sense of the present invention is understood to mean that the desired properties imparted by the finishing agent, for example antistatic and/or hydrophilic properties, are not or hardly reduced even after repeated washing in domestic washing machines. Preferably, the desired properties do not deteriorate after 10-20 or 5-10 washes in domestic washing machines or by no more than 20%.

Surprisingly, the wash-permanent finishing could be achieved not only with natural fibres but also in particular with synthetic fibres such as PE, PA, PAN and PP, which are usually difficult to finish and hardly washable due to lack of, fewer or inert functional groups. The compositions according to the invention can be applied in a simple method, for example in (domestic) washing machines. In addition, the composition of the present invention is stable in a broad concentration range. “Stable” in the sense of the invention means that no sediment is formed. In the case of the concentrate, no sediment formation is preferably observed after 3 months, more preferably after 6 months, even more preferably after 12 months, at 4° C., at 25-30° C. or at 40° C. Also, no sediment forms in the wash water. This property of the composition means that the textiles can be finished homogeneously and that no sediments or deposits form on the materials to be finished.

In the following, the invention will be illustrated by way of examples.

Materials

Poly-DADMAC: Polydiallyldimethylammonium chloride, active substance 53%

Copolymer DADMAC/diallylamine: Active substance 38%

Hostapur SAS 60: C13-C17 secondary alkanesulphonate, sodium salt, active substance 60%

Hordaphos 222: C12-C14 hydrocarbon radical, 4 EO, phosphate, active substance 100%

Lutensol TO 20: C13 hydrocarbon radical, 20 EO, alkyl polyethylene glycol ether-based, active substance 100%

Marlipal 16/18-25: C16-C18 hydrocarbon radical, 25 EO, alkyl polyethylene glycol ether-based, active substance 100%

Dowanol DPM: dipropylene glycol monomethyl ether

### EXAMPLE 1

48 g of water are introduced in a beaker with stirrer (agitator). While stirring, 15 g of the fatty alcohol “Lutensol TO-20” (C13, 20EO) are added. The mixture is heated to 80° C. while the surfactant is completely dissolved. Next, 17 g of a secondary alkanesulphonate (Hostapur SAS 60) are added and dissolved. Successively, 10 g of Dowanol (dipropylene glycol monomethyl ether) and 10 g of aqueous poly-DADMAC (active substance 53%) are added. The initially turbid mixture is cooled while stirring. This forms a clear colloid solution.

A liquor is prepared by diluting 40 g of the resulting product to 1000 mL with water. The textiles to be finished are finished with the product by dipping in the liquor and subsequent squeezing (padding). The pressure on the padder is chosen so that the wet pickup is 100%.

After 3, 5 and 10 household washes, the antistatic and hydrophilic properties are measured according to DIN EN 1149-1 or the TEGEWA drip test.

Polyester (polyethylene terephthalate, knitted fabric): Zero value antistatic 1.0×10¹⁴ ohms, hydrophilicity >180 sec.

| | Antistatic after | Antistatic after | Antistatic after | Sinking time after | Sinking time after | Sinking time after |
|---|---|---|---|---|---|---|
| | 3 washes 40° C. | 5 washes 40° C. | 10 washes 40° C. | 3 washes 40° C. | 5 washes 40° C. | 10 washes 40° C. |
| Finishing | [ohm] | [ohm] | [ohm] | [s] | [s] | [s] |
| Example 1 | 1.10E+11 | 4.60E+10 | 4.20E+11 | 5 | 8 | 9 |

Polyamide 6.6, knitted fabric: Zero value antistatic 1.0×10¹⁴ ohms, hydrophilicity >80 sec.

| | Antistatic after | Antistatic after | Antistatic after | Sinking time after | Sinking time after | Sinking time after |
|---|---|---|---|---|---|---|
| | 3 washes 40° C. | 5 washes 40° C. | 10 washes 40° C. | 3 washes 40° C. | 5 washes 40° C. | 10 washes 40° C. |
| Finishing | [ohm] | [ohm] | [ohm] | [s] | [s] | [s] |
| Example 1 | 9.50E+10 | 5.00E+10 | 2.90E+11 | 6 | 9 | 10 |

Polyacrylonitrile (woven fabric): Zero value antistatic 1.0×10¹⁴ ohms, hydrophilicity >10 sec.

| | Antistatic after | Antistatic after | Antistatic after | Sinking time after | Sinking time after | Sinking time after |
|---|---|---|---|---|---|---|
| | 3 washes 40° C. | 5 washes 40° C. | 10 washes 40° C. | 3 washes 40° C. | 5 washes 40° C. | 10 washes 40° C. |
| Finishing | [ohm] | [ohm] | [ohm] | [s] | [s] | [s] |
| Example 1 | 3.40E+10 | 6.00E+10 | 1.40E+10 | 3 | 3 | 5 |

### EXAMPLE 2: WASHCLOTH

Preparation of the Composition

47.4 g of water are introduced in a beaker with stirrer (agitator). While stirring, 15 g of the fatty alcohol “Lutensol TO-20” (C13, 20EO) are added. Next, 5 g of butyldiglycol are added. The mixture is heated to 90° C. while the surfactant is completely dissolved. Next, 13.8 g of an alkoxylated (4EO) phosphoric acid ester (Hordaphos 222) are added and dissolved. Successively, 1.66 g of sodium hydroxide solution (50%) and 9.2 g of aqueous poly-DADMAC (active substance 53%) are added. The initially turbid mixture is cooled while stirring. This forms a clear colloid solution.

Production of the Washcloth

The washcloth comprises a substrate of polypropylene spun fibre fabric with an area of 900 cm². The substrate has a mass of 17.3 g.

The substrate is finished by dipping in the resulting composition and then squeezing (padding). The pressure on the padder is chosen so that the wet pickup is 200%. Next, the finished substrate is dried at 120° C. for 2 minutes.

Application of Washcloth and Results

The washcloth thus obtained is washed together with a 0.6 kg accessory pack (household washing at 40° C.). The accessory pack consists of 0.3 kg of polyester (polyethylene terephthalate, knitted fabric) and of 0.3 kg of polyamide (polyamide 6,6; knitted fabric)

After household washing, the accessory pack is dried for 2 days in air and conditioned for 3 days in an air-conditioned room. Next, antistatic and hydrophilic properties are measured. In order to check for homogeneous finishing, the accessory pack is tested in four different places.

Polyester (polyethylene terephthalate, knitted fabric):

Zero value antistatic 1.0×10¹⁴ ohms, hydrophilicity >180 sec.

Accessory pack PES

| Antistatic [ohm] | Sinking time [s] |
|---|---|
| 2.70E+10 | 3 |
| 3.40E+10 | 3 |
| 2.80E+10 | 4 |
| 2.50E+10 | 3 |

Polyamide 6,6; knitted fabric:

Zero value antistatic 1.0×10¹⁴ ohms, hydrophilicity >80 sec.

Accessory pack PA

| Antistatic [ohm] | Sinking time [s] |
|---|---|
| 1.20E+11 | 2 |
| 9.50E+10 | 3 |
| 9.50E+10 | 2 |
| 1.10E+11 | 2 |

### EXAMPLE 3: WASHCLOTH

Preparation of the Composition

43.0 g of water are introduced in a beaker with stirrer (agitator). While stirring, 30 g of the fatty alcohol “Lutensol TO-20” (C13, 20EO) are added. The mixture is heated to 90° C. while the surfactant is completely dissolved. Next, 17.0 g of a secondary alkanesulphonate sodium salt (Hostapur SAS 60, active substance 60%) are added and dissolved. The mixture is cooled to 60° C. At this temperature, 9.2 g of aqueous poly-DADMAC (active substance 53%) are added. The initially turbid mixture is cooled while stirring. This forms a clear colloid solution.

Production of the Washcloth

Analogously to Example 2, the same proportions are used in the scale 1:10.

The washcloth comprises a polypropylene spun fibre fabric substrate with an area of 90 cm². The substrate has a mass of 1.0 g.

The substrate is finished by dipping in the resulting composition and then squeezing (padding). The pressure on the padder is chosen so that the wet pickup is 240%. Next, the finished substrate is dried at 120° C. for 2 minutes.

Application of Washcloth and Results

The washcloth thus obtained is washed together with a 60 g accessory pack (household washing at 40° C.). The accessory pack consists of 30 g polyester (polyethylene terephthalate, knitted fabric) and 30 g polyamide (polyamide 6,6; knitted fabric). The accessory pack simulates the textiles to be finished by the end user.

After household washing, the accessory pack is dried for 2 days in air and conditioned for 3 days in an air-conditioned room. Next, antistatic and hydrophilic properties are measured. In order to check for homogeneous finishing, the accessory pack is tested in three different places.

Polyester (polyethylene terephthalate, knitted fabric):

Zero value antistatic 1.0×10¹⁴ ohms, hydrophilicity >180 sec.

Accessory pack PES

| Antistatic [ohm] | Sinking time [s] |
|---|---|
| 1.00E+10 | 3 |
| 1.10E+10 | 3 |
| 8.00E+09 | 3 |

Polyamide 6,6; knitted fabric):

Zero value antistatic 1.0×10¹⁴ ohms, hydrophilicity >80 sec.

Accessory pack PA

| Antistatic [ohm] | Sinking time [s] |
|---|---|
| 4.80E+09 | 15 |
| 4.20E+09 | 11 |
| 3.60E+09 | 10 |

In order to test the washing permanence of the product finished by this method (=accessory pack), the accessory pack was washed again 3, 5 and times. The mean values of the measurements are shown as results. Polyester (polyethylene terephthalate, knitted fabric):

| | Antistatic after | Antistatic after | Antistatic after | Sinking time after | Sinking time after | Sinking time after |
|---|---|---|---|---|---|---|
| | 3 washes 40° C. | 5 washes 40° C. | 10 washes 40° C. | 3 washes 40° C. | 5 washes 40° C. | 10 washes 40° C. |
| Finishing | [ohm] | [ohm] | [ohm] | [s] | [s] | [s] |
| Accessory | 5.50E+10 | 9.50E+10 | 5.50E+10 | 4 | 5 | 7 |
| pack PES in | | | | | | |
| example 3 | | | | | | |

Polyamide 6,6; knitted fabric):

| | Antistatic after | Antistatic after | Antistatic after | Sinking time after | Sinking time after | Sinking time after |
|---|---|---|---|---|---|---|
| | 3 washes 40° C. | 5 washes 40° C. | 10 washes 40° C. | 3 washes 40° C. | 5 washes 40° C. | 10 washes 40° C. |
| Finishing | [ohm] | [ohm] | [ohm] | [s] | [s] | [s] |
| Accessory | 3.40E+10 | 9.00E+10 | 1.00E+11 | 13 | 8 | 21 |
| pack PA in | | | | | | |
| example 3 | | | | | | |

### EXAMPLE 4: WASHCLOTH

Preparation of the Composition

58.0 g of water are introduced in a beaker with stirrer (agitator). While stirring, 15 g of the fatty alcohol “Lutensol TO-20” (C13, 20EO) are added. The mixture is heated to 90° C. while the surfactant is completely dissolved. Next, 17.0 g of a secondary alkanesulphonate sodium salt (Hostapur SAS 60, active substance 60%) are added and dissolved. The mixture is cooled to 60° C. At this temperature, 9.2 g of aqueous poly-DADMAC (active substance 53%) are added. The initially turbid mixture is cooled while stirring. This forms a clear colloid solution.

Production of the Washcloth

The washcloth comprises a polypropylene spun fibre fabric substrate with an area of 90 cm². The substrate has a mass of 1.0 g.

The substrate is finished by dipping in the resulting composition and then squeezing (padding). The pressure on the padder is chosen so that the wet pickup is 240%. Next, the finished substrate is dried at 120° C. for 2 minutes.

Application of Washcloth and Results

The washcloth thus obtained is washed together with a 60 g accessory pack (household washing at 40° C.). The accessory pack consists of 30 g polyester (polyethylene terephthalate, knitted fabric) and 30 g polyamide (polyamide 6,6; knitted fabric). The accessory pack simulates the textiles to be finished by the end user.

After household washing, the accessory pack is dried for 2 days in air and conditioned for 3 days in an air-conditioned room. Next, antistatic and hydrophilic properties are measured. In order to check for homogeneous finishing, the accessory pack is tested in three different places.

Polyester (polyethylene terephthalate, knitted fabric):

Zero value antistatic 1.0×10¹⁴ ohms, hydrophilicity >180 sec.

Accessory pack PES

| Antistatic [ohm] | Sinking time [s] |
|---|---|
| 5.50E+09 | 2 |
| 5.00E+09 | 2 |
| 5.50E+09 | 2 |

Polyamide 6,6; knitted fabric):

Zero value antistatic 1.0×10¹⁴ ohms, hydrophilicity >80 sec.

Accessory pack PA

| Antistatic [ohm] | Sinking time [s] |
|---|---|
| 4.20E+09 | 3 |
| 4.80E+09 | 5 |
| 6.00E+09 | 3 |

In order to test the washing permanence of the product finished by this method (=accessory pack), the accessory pack was washed again 3, 5 and times. The mean values of the measurements are shown as results.

Polyester (polyethylene terephthalate, knitted fabric):

| | Antistatic after | Antistatic after | Antistatic after | Sinking time after | Sinking time after | Sinking time after |
|---|---|---|---|---|---|---|
| | 3 washes 40° C. | 5 washes 40° C. | 10 washes 40° C. | 3 washes 40° C. | 5 washes 40° C. | 10 washes 40° C. |
| Finishing | [ohm] | [ohm] | [ohm] | [s] | [s] | [s] |
| Pack PES in | 1.40E+11 | 1.10E+11 | 9.50E+10 | 3 | 4 | 8 |
| example 4 | | | | | | |

Polyamide 6,6; knitted fabric):

| | Antistatic after | Antistatic after | Antistatic after | Sinking time after | Sinking time after | Sinking time after |
|---|---|---|---|---|---|---|
| | 3 washes 40° C. | 5 washes 40° C. | 10 washes 40° C. | 3 washes 40° C. | 5 washes 40° C. | 10 washes 40° C. |
| Finishing | [ohm] | [ohm] | [ohm] | [s] | [s] | [s] |
| Accessory | 7.00E+10 | 1.30E+11 | 2.60E+11 | 4 | 4 | 19 |
| pack PA in | | | | | | |
| example 4 | | | | | | |

### EXAMPLE 5: WASHCLOTH

Preparation of the Composition

55.37 g of water are introduced in a beaker with stirrer (agitator). While stirring, 15 g of the fatty alcohol “Lutensol TO-20” (C13, 20EO) are added. Next, 5 g of butyldiglycol are added. The mixture is heated to 90° C. while the surfactant is completely dissolved. Next, 13.8 g of an alkoxylated (4EO) phosphoric acid ester (Hordaphos 222) are added and dissolved. The mixture is cooled to 60° C. At this temperature, 1.66 g of sodium hydroxide solution (50% strength) and 9.2 g of aqueous poly-DADMAC (active substance 53%) are successively added. The initially turbid mixture is cooled while stirring. This forms a clear colloid solution.

Production of the Washcloth

The washcloth comprises a polypropylene spun fibre fabric substrate with an area of 90 cm². The substrate has a mass of 1.0 g.

The substrate is finished by dipping in the resulting composition and then squeezing (padding). The pressure on the padder is chosen so that the wet pickup is 240%. Next, the finished substrate is dried at 120° C. for 2 minutes.

Application of Washcloth and Results

The washcloth thus obtained is washed together with a 60 g accessory pack (household washing at 40° C.). The accessory pack consists of 30 g polyester (polyethylene terephthalate, knitted fabric) and 30 g polyamide (polyamide 6,6; knitted fabric). The accessory pack simulates the textiles to be finished by the end user.

After household washing, the accessory pack is dried for 2 days in air and conditioned for 3 days in an air-conditioned room. Next, antistatic and hydrophilic properties are measured. In order to check for homogeneous finishing, the accessory pack is tested in three different places.

Polyester (polyethylene terephthalate, knitted fabric):

Zero value antistatic 1.0×10¹⁴ ohms, hydrophilicity >180 sec.

Accessory pack PES

| Antistatic [ohm] | Sinking time [s] |
|---|---|
| 2.10E+08 | 2 |
| 2.40E+08 | 2 |
| 2.80E+08 | 2 |

Polyamide 6,6; knitted fabric):

Zero value antistatic 1.0×10¹⁴ ohms, hydrophilicity >80 sec.

Accessory pack PA

| Antistatic [ohm] | Sinking time [s] |
|---|---|
| 1.30E+08 | 2 |
| 2.40E+08 | 2 |
| 2.10E+08 | 2 |

In order to test the washing permanence of the product finished by this method (=accessory pack), the accessory pack was washed again 3, 5 and times. The mean values of the measurements are shown as results.

Polyester (polyethylene terephthalate, knitted fabric):

| | Antistatic after | Antistatic after | Antistatic after | Sinking time after | Sinking time after | Sinking time after |
|---|---|---|---|---|---|---|
| | 3 washes 40° C. | 5 washes 40° C. | 10 washes 40° C. | 3 washes 40° C. | 5 washes 40° C. | 10 washes 40° C. |
| Finishing | [ohm] | [ohm] | [ohm] | [s] | [s] | [s] |
| Accessory | 2.80E+10 | 3.80E+10 | 7.00E+10 | 4 | 5 | 11 |
| pack PES in | | | | | | |
| example 5 | | | | | | |

Polyamide 6,6; knitted fabric):

| | Antistatic after | Antistatic after | Antistatic after | Sinking time after | Sinking time after | Sinking time after |
|---|---|---|---|---|---|---|
| | 3 washes 40° C. | 5 washes 40° C. | 10 washes 40° C. | 3 washes 40° C. | 5 washes 40° C. | 10 washes 40° C. |
| Finishing | [ohm] | [ohm] | [ohm] | [s] | [s] | [s] |
| Accessory | 2.20E+10 | 8.00E+10 | 1.30E+11 | 4 | 10 | 10 |
| pack PA in | | | | | | |
| example 5 | | | | | | |

### EXAMPLE 6: WASHCLOTH

Preparation of the Composition

50.37 g of water are introduced in a beaker with stirrer (agitator). While stirring, 15 g of “Marlipal 16/18-25” (C16-C18, 25EO) are added. Next, 10 g of Dowanol DPM are added. The mixture is heated to 90° C. while the surfactant is completely dissolved. Next, 13.8 g of an alkoxylated (4EO) phosphoric acid ester (Hordaphos 222) are added and dissolved. The mixture is cooled to 60° C. At this temperature, 1.66 g of sodium hydroxide solution (50% strength) and 9.2 g of aqueous poly-DADMAC (active substance 53%) are successively added. The initially turbid mixture is cooled while stirring. This forms a clear colloid solution.

Production of the Washcloth

The washcloth comprises a polypropylene spun fibre fabric substrate with an area of 90 cm². The substrate has a mass of 1.0 g.

The substrate is finished by dipping in the resulting composition and then squeezing (padding). The pressure on the padder is chosen so that the wet pickup is 240%. Next, the finished substrate is dried at 120° C. for 2 minutes.

Application of Washcloth and Results

The washcloth thus obtained is washed together with a 60 g accessory pack (household washing at 40° C.). The accessory pack consists of 30 g polyester (polyethylene terephthalate, knitted fabric) and 30 g polyamide (polyamide 6,6; knitted fabric). The accessory pack simulates the textiles to be finished by the end user.

After household washing, the accessory pack is dried for 2 days in air and conditioned for 3 days in an air-conditioned room. Next, antistatic and hydrophilic properties are measured. In order to check for homogeneous finishing, the accessory pack is tested in three different places.

Polyester (polyethylene terephthalate, knitted fabric):

Zero value antistatic 1.0×10¹⁴ ohms, hydrophilicity >180 sec.

Accessory pack PES

| Antistatic [ohm] | Sinking time [s] |
|---|---|
| 5.00E+11 | 3 |
| 1.80E+11 | 2 |
| 1.70E+11 | 2 |

Polyamide 6,6; knitted fabric):

Zero value antistatic 1.0×10¹⁴ ohms, hydrophilicity >80 sec.

Accessory pack PA

| Antistatic [ohm] | Sinking time [s] |
|---|---|
| 7.50E+08 | 1 |
| 4.00E+08 | 1 |
| 4.60E+08 | 1 |

In order to test the washing permanence of the product finished by this method (=accessory pack), the accessory pack was washed again 3, 5 and times. The mean values of the measurements are shown as results.

Polyester (polyethylene terephthalate, knitted fabric):

| | Antistatic after | Antistatic after | Antistatic after | Sinking time after | Sinking time after | Sinking time after |
|---|---|---|---|---|---|---|
| | 3 washes 40° C. | 5 washes 40° C. | 10 washes 40° C. | 3 washes 40° C. | 5 washes 40° C. | 10 washes 40° C. |
| Finishing | [ohm] | [ohm] | [ohm] | [s] | [s] | [s] |
| Accessory | 2.60E+11 | 6.50E+11 | 8.00E+11 | 23 | 29 | 180 |
| pack PES in | | | | | | |
| example 6 | | | | | | |

Polyamide 6,6; knitted fabric):

| | Antistatic after | Antistatic after | Antistatic after | Sinking time after | Sinking time after | Sinking time after |
|---|---|---|---|---|---|---|
| | 3 washes 40° C. | 5 washes 40° C. | 10 washes 40° C. | 3 washes 40° C. | 5 washes 40° C. | 10 washes 40° C. |
| Finishing | [ohm] | [ohm] | [ohm] | [s] | [s] | [s] |
| Accessory | 4.80E+11 | 8.00E+11 | 1.10E+12 | 20 | 12 | 62 |
| pack PA in | | | | | | |
| example 6 | | | | | | |

1. A composition comprising:
(A) at least one cationic polyelectrolyte,
(B) at least one anionic compound
(C) at least one non-ionic surfactant and
(D) optionally, at least one liquid medium.

2. The composition according to claim 1 in the form of a colloid.

3.-5. (canceled)

6. The composition according to claim 1, wherein the polyelectrolyte (A) is obtainable by (i) polymerisation of at least three monomer units, each having a permanently cationic charge and/or (ii) by condensation reactions leading to at least three cationic groups, and/or (iii) by alkylation of at least three amino functions in a polymer to permanent cationic groups.

7.-8. (canceled)

9. The composition according to claim 6, wherein the monomer unit (i) comprises an ammonium, pyridinium, imidazolium, pyrrolidinium group or an N-substituted heteroaromatic group.

10. (canceled)

11. The composition according to claim 6, wherein the condensation reaction (ii) comprises a reaction of at least one di-alkylamine, tertiary alkyl and/or (hetero)aryl-diamine with at least one epihalohydrin and/or bis-halide.

12. The composition according to claim 6, wherein the polymer having at least three amino functions in (iii) is selected from the group consisting of linear or branched polyalkyleneimine, in particular polyethyleneimine, or is obtainable by polymerisation of at least three monomer units selected from the group consisting of diallyldialkylamine, vinylamine, vinylpyrazole, vinylimidazole and/or aziridine.

13.-15. (canceled)

16. The composition according to claim 1, wherein the anionic compound (B) has at least one, preferably 1-3, anionic group (s) or is an anionic polyelectrolyte.

17. The composition according to claim 16, wherein the anionic compound (B) comprises at least one phosphate, phosphonate, sulphate, sulphonate, carboxylate, sulphoacetate, sulphosuccinate and/or taurate group.

18.-24. (canceled)

25. The composition according to claim 1, wherein the component (A) and the component (B) together form an ionic complex.

26. The composition according to claim 1, wherein the ratio of the net charge in component (A) to the net charge in component (B) is 1:10 to 10:1, preferably 1:7 to 7:1.

27. (canceled)

28. The composition according to claim 1, wherein the component (C) is an alkoxylation product of fatty acid, fatty acid ester, fatty acid amine, fatty acid amide, fatty alcohol, aliphatic mono-, di- or tri-alcohol, mono-, di- or tri-glyceride, alkylphenol, sorbitan fatty acid and sugar derivatives, or trialkylphenol polyalkoxylene or a block copolymer, for example, poly(ethylene oxide-co-propylene oxide).

29. (canceled)

30. The composition according to claim 1, wherein the liquid medium (D) is selected from water, an organic solvent, preferably alcohol, glycol(ether), ether, ketone or mixtures thereof.

31. (canceled)

32. The composition according to claim 1, further comprising at least one textile auxiliary, e.g. an antistatic agent, a hydrophilising agent, a flame retardant, a softening agent, a de-wrinkling agent, a lubricant, a UV resistance agent, a corrosion inhibitor or a fluorine-free or fluoric hydrophobising agent.

33. A dosing unit comprising a composition according to any claim 1, in particular in the form of a washcloth, tabs, caps, pods or a dosing device.

34. The dosing unit according to claim 33, wherein the washcloth comprises a substrate, e.g. knitted fabric, a fleece, woven fabric, or felt.

35.-36. (canceled)

37. The dosing unit according to claim 33, wherein the mass ratio of the components (A), (B) and (C) in the composition to the substrate is 1:1 or 10:1 to 0.5:1.

38.-39. (canceled)

40. The method of making a washcloth according to claim 33 comprising:
(i) providing a substrate,
(ii) applying the composition to the substrate and
(iii) optionally, at least partially removing the liquid medium (D) at temperatures above room temperature and optionally at reduced pressure.

41. A method for antistatic and/or hydrophilising finishing of textiles by providing a dosing unit according to claim 33 to a textile treatment.

42. The method according to claim 41, wherein the textile treatment is in washing machines, in particular domestic washing machines.
